(19) United States
(12) Patent Application Publication
(10) Pub. No.: US 2018/0200967 A1
(43) Pub. Date: Jul. 19, 2018

(54) METHOD AND TOOLING FOR FORMING A FLANGE OF A COMPOSITE COMPONENT

(71) Applicant: General Electric Company, Schenectady, NY (US)

(72) Inventors: Thomas Michael Sutter, Cincinnati, OH (US); Joseph Thomas Begovich, JR., West Chester, OH (US); Matthew Elias Voznick, Ontario, CA (US); Dennis Mason Diem, Long Beach, CA (US); Kevin Stanley Snyder, Lake Arrowhead, CA (US); Leslie Louis Langenbrunner, Cincinnati, OH (US); Ming Xie, Beavercreek, OH (US)

(21) Appl. No.: 15/410,172

(22) Filed: Jan. 19, 2017

(51) Int. Cl. B29C 70/34; B29C 70/54

(52) U.S. Cl. CPC B29C 70/342; B29L 2031/7504; B29C 70/54

(57) ABSTRACT

A tooling assembly and method for forming a flange of a composite component is provided. The tooling assembly includes a mold configured to receive a composite material. The composite material may include a plurality of fabric plies impregnated with resin. The fabric plies may be debulked as they are being laid using a plurality of debulking tools, with the radius of each debulking tool growing as additional fabric plies are laid. A gas-permeable bagging material may be placed along the edge of the composite material to restrict resin flow while allowing for outgassing. The tooling assembly may further include a flange shoe tool that is joined with the mold to form the flange of the composite material. The mold and flange shoe tool may define a chamber and venting passageways that allow gases such as volatile compounds to escape while the composite component is being cured.

### FEDERAL RESEARCH STATEMENT

This invention was made with Government support under Contract No. FA8650-09-D-2922, awarded by the U.S. Department of the Air Force. The Government has certain rights in the invention.

### FIELD OF THE INVENTION

The present subject matter relates generally to gas turbine engines, and more specifically, to improved tooling and methods for manufacturing composite components for a gas turbine engine.

### BACKGROUND OF THE INVENTION

A gas turbine engine generally includes a fan and a core arranged in flow communication with one another. Additionally, the core of the gas turbine engine generally includes, in serial flow order, a compressor section, a combustion section, a turbine section, and an exhaust section. In operation, air is provided from the fan to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gases through the turbine section drives the turbine section and is then routed through the exhaust section, e.g., to atmosphere.

The fan portion of certain conventional gas turbine engines may include one or more stages of fan blades rotatably or fixedly mounted within a fan casing. Similarly the core of the gas turbine engine may be housed within a nacelle or core housing. To simplify maintenance and interchangeability of the fan and core portions of such gas turbine engines, the fan casing and the core nacelle are typically separate assemblies that are mounted together along an axial direction by flanges. In addition, to simplify access to the working components of each section, the housings are typically two separable components joined along a split line flange. In this manner, for example, fan casing may include a top half and a bottom half which may be separated to allow for fan maintenance.

In addition, many components of conventional gas turbine engines are manufactured with composite materials to reduce weight and improve the propulsive efficiency of the gas turbine engine and aircraft. For example, it may be desirable to form the fan casing from a composite material. Conventional composite materials include a plurality of fabric plies impregnated with resin or another matrix material. Notably, conventional processes for forming sharp corners or angles, such as flanges of the fan casing, with impregnated fabric plies can result in interlaminar porosity. In addition, evacuating volatile compounds and solvents of certain resin systems during curing may be difficult, particularly in the corners of the impregnated fabric plies, resulting in additional porosity. Notably, porosity is undesirable as it can degrade the strength of the composite component.

Accordingly, improved tooling and methods for forming composite components with decreased porosity would be especially beneficial, especially to certain resins with large quantities of solvents or with cure chemistries which generate volatile components.

### BRIEF DESCRIPTION OF THE INVENTION

Aspects and advantages of the invention will be set forth in part in the following description, or may be obvious from the description, or may be learned through practice of the invention.

In one exemplary embodiment of the present disclosure, a tooling assembly for forming a flange of a composite component is provided. The tooling assembly includes a mold configured to receive a composite material, the mold defining a primary molding surface and a flange molding surface, the flange molding surface extending at an angle relative to the primary molding surface, the mold defining a plurality of venting passageways that extend through the flange molding surface. The tooling assembly further includes a flange shoe tool that is joined with the mold to form the flange along an edge of the composite material, the flange shoe tool and the mold defining a chamber adjacent the edge of the composite material, the chamber being in fluid communication with the plurality of venting passageways.

In another exemplary embodiment of the present disclosure, a method of forming a flange of a composite component is provided. The method includes laying a composite material in a mold, the mold defining a flange forming surface and a plurality of venting passageways. A flange shoe tool is positioned along an edge of the composite material to form the flange, the flange shoe tool and the mold defining a chamber adjacent the composite material, the chamber being in fluid communication with the plurality of venting passageways. The composite component is vacuum bagged by placing a vacuum bag over the mold, the flange shoe tool, and the composite component and evacuating gas from within the vacuum bag through one or more vacuum ports in fluid communication with the vacuum bag.

In still another embodiment of the present disclosure, a method of forming a composite component from fabric plies impregnated with a matrix material is provided. The method includes laying a first plurality of fabric plies in a mold, the mold defining a flange corner and a venting passageway allowing for the escape of gas, and debulking the first plurality of fabric plies by pressing the first plurality of fabric plies into the flange corner using a first debulking tool having a first radius and vacuum bagging the mold and the first debulking tool. The method further includes laying a second plurality of fabric plies in the mold on top of the first plurality of fabric plies and debulking the second plurality of fabric plies by pressing the second plurality of fabric plies into the flange corner using a second debulking tool having a second radius and vacuum bagging the mold and the second debulking tool, the second radius being smaller than the first radius.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a perspective view of an exemplary gas turbine engine according to various embodiments of the present subject matter.

FIG. 2 provides an exploded view of a fan casing of the exemplary gas turbine engine of FIG. 1.

FIG. 3 provides a perspective view of the composite component laid in a mold with a flange shoe tool attached to a portion of the mold for forming a flange of the composite component according to an exemplary embodiment of the present subject matter.

FIG. 4 provides a cross sectional view of the composite component, the mold, and the flange shoe tool fully engaged to form the flange of the composite component, as taken along Line 4-4 of FIG. 3.

FIG. 5 provides a perspective view of a composite material laid in a mold and being formed using a debulking tool according to an exemplary embodiment of the present subject matter.

FIG. 6 provides a schematic view of a composite preform being formed using two debulking tools having different radii according to an exemplary embodiment of the present subject matter.

FIG. 7 provides a perspective view of the exemplary mold and debulking tool placed in a vacuum bag during a vacuum bagging procedure according to an exemplary embodiment of the present subject matter.

FIG. 8 provides a perspective view of a composite component preform positioned within the mold according to an exemplary embodiment of the present subject matter.

FIG. 9 illustrates a method for forming a flange of a composite component according to an exemplary embodiment of the present subject matter.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. Further, as used herein, the terms “axial” or “axially” refer to a dimension along a longitudinal axis of an engine. The term “forward” used in conjunction with “axial” or “axially” refers to a direction toward the engine inlet, or a component being relatively closer to the engine inlet as compared to another component. The term “rear” used in conjunction with “axial” or “axially” refers to a direction toward the engine nozzle, or a component being relatively closer to the engine nozzle as compared to another component. The terms “radial” or “radially” refer to a dimension extending between a center longitudinal axis of the engine and an outer engine circumference.

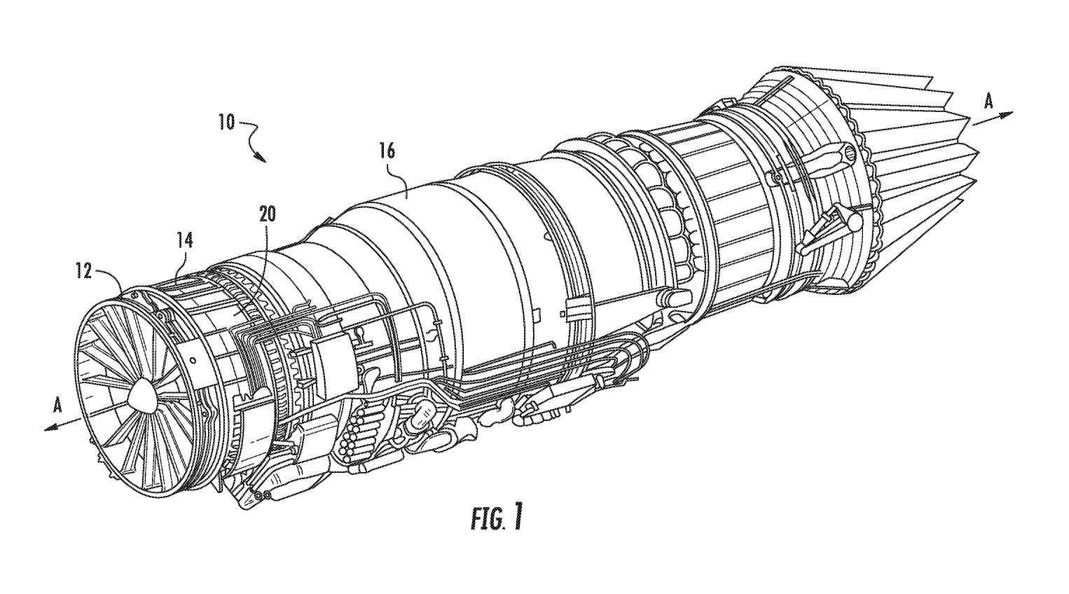

Referring now to the drawings, FIG. 1 is a perspective view of an exemplary gas turbine engine 10 as may incorporate various embodiments of the present disclosure. As illustrated in FIG. 1, gas turbine engine 10 has a longitudinal centerline axis corresponding to the axial direction A. In general, gas turbine engine 10 includes various sections that are operably coupled together to provide thrust to an aircraft. For example, the exemplary gas turbine engine 10 illustrated in FIG. 1, has a forward fan stage 12, a rotary fan stage 14, and a core engine 16 arranged along axial direction A. The operating details of each of these sections are beyond the scope of this application. In order to improve accessibility to each stage of gas turbine engine 10, the working components of each stage are typically encased in a housing or casing.

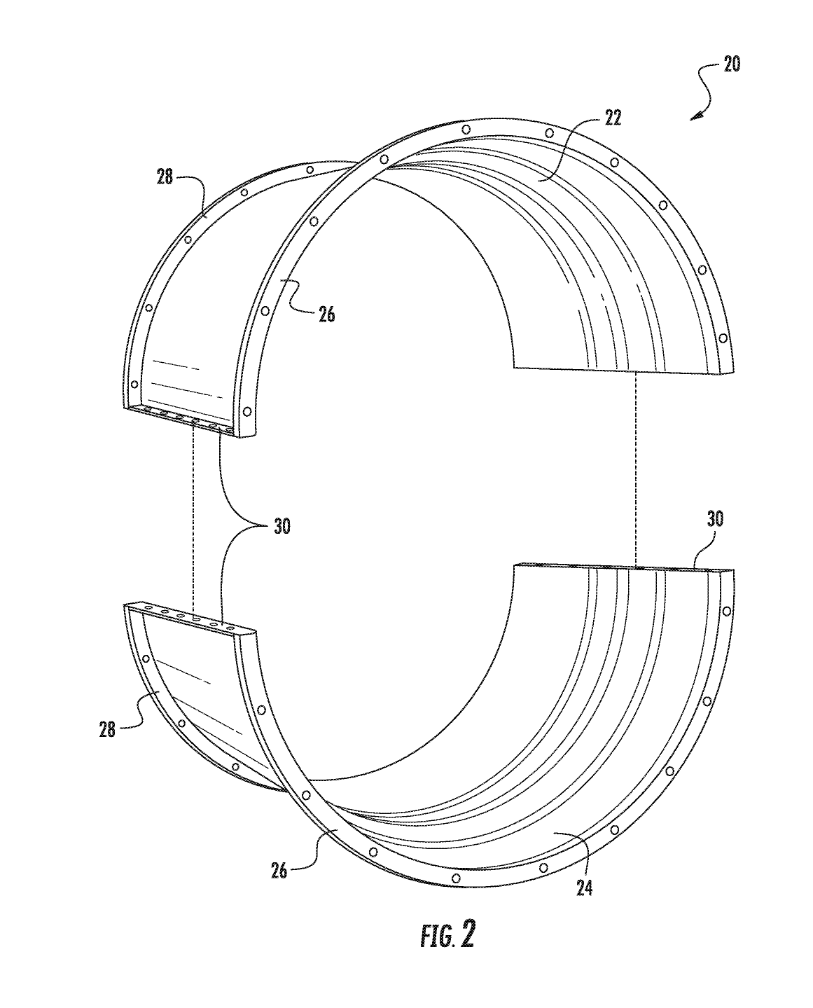

Such casings are typically constructed in two or more pieces so that they may be easily removed to access the working components housed within the housings or the casings. This may simplify maintenance, repair, and or replacement of various components of gas turbine engine 10. A common construction of such housings is a clamshell construction, i.e., each cylindrical casing is separated into two halves, a top and a bottom. For example, using rotary fan stage 14 as an example here and throughout the rest of this disclosure, a fan casing 20 may be included to protect the operating components of rotary fan stage 14. More specifically, as illustrated in FIG. 2, fan casing 20 may have a top portion 22 and a bottom portion 24 that are connected using mechanical fasteners, such as bolts, rivets, etc. Alternatively, top portion 22 and bottom portion 24 may be coupled using any suitable means, such as mechanical clips, welding, adhesive, etc.

Notably, attaching top portion 22 and bottom portion 24 may require that fan casing 20 have stand-up flanges, e.g., which extend ninety degrees relative to the surface of fan casing 20 and provide a sufficiently rigid means for connecting top portion 22 and bottom portion 24. For example, each of top portion 22 and bottom portion 24 may include a forward flange 26, an aft flange 28, and an axial split line flange 30. The axial split line flanges 30 are configured for coupling top portion 22 and bottom portion 24 of fan casing 20. In addition, the forward flanges 26 and the aft flanges 28 are configured for coupling fan casing 20 to complementary flanges on forward fan stage 14 and core engine 16, respectively.

In order to reduce weight without sacrificing the strength of fan casing 20, composite materials may be used. For example, fabric plies may be bonded together using a matrix material to form a strong, lightweight composite material that can withstand high heat operation of gas turbine engine 10, while improving aircraft propulsive efficiency. According to one embodiment, the fabric plies may be carbon fiber fabric plies or glass fiber fabric plies and the matrix material may be a resin. According to another embodiment, the resin may include polyimide compounds sufficient to withstand high temperature operation. According to still other embodiments, a ceramic matrix composite (“CMC”) material may be used. It should be appreciated that other suitable fabric and binder composites may also be used while remaining within the scope of the present subject matter. Moreover, although the discussion below refers to fan casing 20 and its method of construction, it should be appreciated that aspects of the present subject matter may be similarly applied to other components of gas turbine engine 10, such as a front frame, a bypass duct, a turbine case, an augmentor duct, an exhaust duct, or any other component having a flange.

For example, ceramic matrix composite (“CMC”) materials have been used as a lightweight, but sufficiently robust alternative to conventional iron, nickel, and cobalt-based superalloys. CMC materials generally comprise a ceramic fiber reinforcement material embedded in a ceramic matrix material. The reinforcement material may be discontinuous short fibers dispersed in the matrix material or continuous fibers or fiber bundles oriented within the matrix material, and serves as the load-bearing constituent of the CMC in the event of a matrix crack. In turn, the ceramic matrix protects the reinforcement material, maintains the orientation of its fibers, and serves to dissipate loads to the reinforcement material.

Fabrication of CMC components generally entails using multiple prepreg layers, each in the form of a “tape,” or a woven or braided textile, comprising the desired ceramic fiber reinforcement material, one or more precursors of the CMC matrix material, and binders. According to conventional practice, prepreg tapes can be formed by impregnating the reinforcement material with a slurry that contains the ceramic precursor(s) and binders. Preferred materials for the precursor, binder, and particulate fillers will depend on the particular composition desired for the ceramic matrix of the CMC component.

After allowing the slurry to partially dry and, if appropriate, partially curing the binders (B-staging), the resulting prepreg tape is laid-up with other tapes. In addition, a debulking process may be performed to eliminate porosity and, if appropriate, the prepreg tape is cured while subjected to elevated pressures and temperatures to produce a preform. The preform is then heated (fired) in a vacuum or inert atmosphere to decompose the binders, remove any remaining solvents, and convert the precursor to the desired ceramic matrix material.

Regardless of the type of fabric plies and the type of matrix material used, forming flanges with such composite materials can be difficult for several reasons. Using carbon fiber fabric plies impregnated with polyimide resin as an example, such a composite material is cured at high temperatures and discharges a large quantity of gases and solvents, e.g., volatile compounds such as methanol and ethanol. For example, curing such a composite material can result in a weight reduction of approximately 25%. Notably, it is important to provide pathways for these volatile compounds to escape from the composite material during preforming and curing. Some exemplary methods for allowing for the outgassing of volatile and other compounds are described herein.

It should be appreciated that the exemplary gas turbine engine 10 depicted in FIG. 1 is provided by way of example only, and that in other exemplary embodiments, the gas turbine engine 10 may have any other suitable configuration. It should also be appreciated, that in still other exemplary embodiments, aspects of the present disclosure may be incorporated into any other suitable gas turbine engine. For example, in other exemplary embodiments, aspects of the present disclosure may be incorporated into, e.g., a turbofan engine, a turboprop engine, a turboshaft engine, or a turbojet engine. Further, in still other embodiments, aspects of the present disclosure may be incorporated into any other suitable turbomachine, including, without limitation, a steam turbine, a centrifugal compressor, and/or a turbocharger. Moreover, aspects of the present disclosure may be used for manufacturing any composite component for any application.

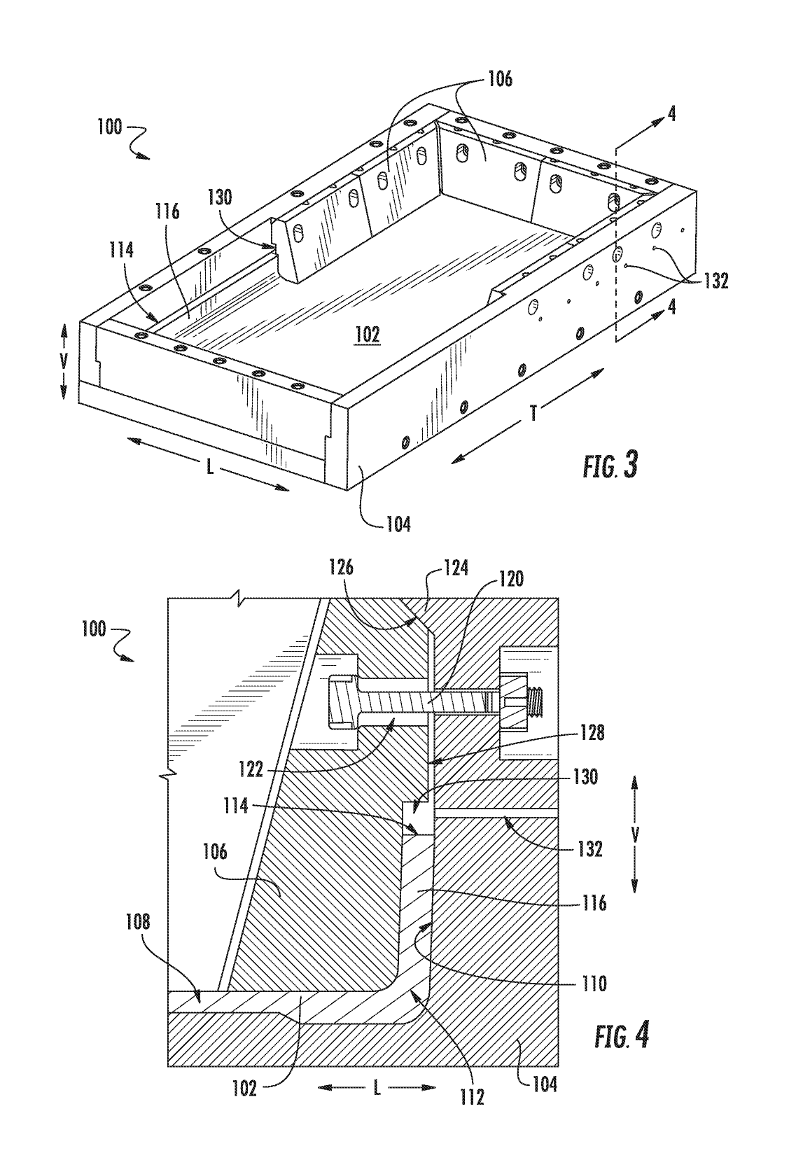

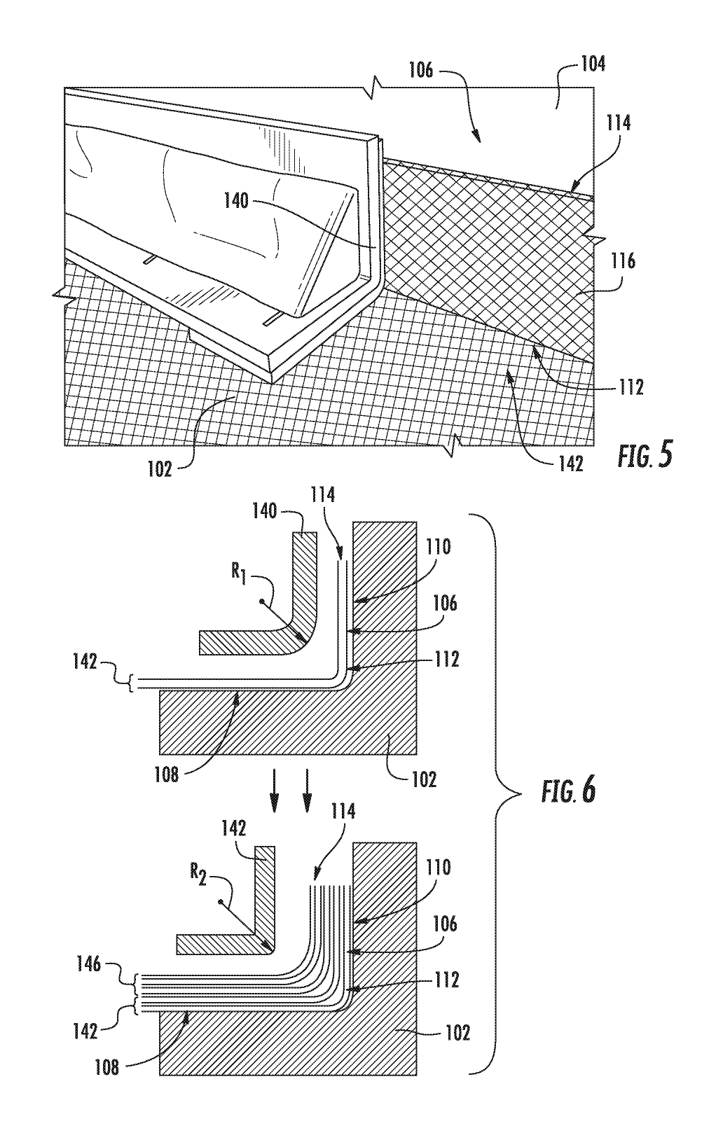

Referring now to FIGS. 3 and 4, a tooling assembly 100 for forming a composite component 102 according to an exemplary embodiment of the present subject matter is provided. More specifically, FIG. 3 provides a perspective view of composite component 102 laid in tooling assembly 100 and FIG. 4 provides a cross sectional view of composite component 102, or more particularly, a flange of composite component 102, being formed by tooling assembly 100. As illustrated, tooling assembly 100 generally includes a mold 104 and a flange shoe tool 106. More particularly, flange shoe tools 106 extend around the perimeter of composite component 102 to form four raised flanges joined at four corners. Half of the flange shoe tools 106 are removed for clarity in FIG. 3.

As will be described below in detail, composite component 102 is generally laid into mold 104 as one or more fabric plies. Various debulking and vacuum bagging procedures may be performed to manipulate composite component 102 into a preform suitable for final forming with flange shoe tool 106. Final forming may include performing a final vacuum bagging and curing procedure on composite component 102. Tooling assembly 100 generally defines a vertical direction V, a lateral direction L, and a transverse direction T, which are mutually perpendicular with one another, such that an orthogonal coordinate system is generally defined. Although the vertical direction V is used herein to describe the orthogonal coordinate system, it should be appreciated that the vertical direction V need not always correspond to a direction parallel to the direction of gravity.

Although composite component 102 is illustrated herein as a flat rectangular component with four upright flanges, it should be appreciated that the shape of composite component 102 is only used herein for the explaining aspects of the present subject matter. According to alternative embodiments, mold 104—and thus composite component 102—may be any suitable shape. For example, according to an exemplary embodiment, mold 104 may be barrel-shaped and may be configured for forming fan casing 20 with integral flanges 26, 28, 30. In addition, mold 104 may be an assembly of different mold parts that are connected together or may be formed as one continuous and integral piece.

In general, mold 104 defines a surface on which composite component 102 may be laid during the forming process described below. More specifically, according to the illustrated exemplary embodiment, mold 104 defines a primary molding surface 108 and a flange molding surface 110 which are configured to receive composite component 102. Flange molding surface 110 may extend at an angle relative to primary molding surface 108. For example, as best illustrated in FIG. 4, flange molding surface 110 extends at an angle of approximately ninety degrees relative to primary molding surface 108. In this regard, primary molding surface 108 extends substantially along the lateral direction L and flange molding surface 110 extends substantially along the vertical direction V. As used herein, when used to specify a directional orientation, “substantially” is intended to refer to within five degrees of the stated direction. So oriented, primary molding surface 108 and flange molding surface 110 may generally define a profile for forming a flange corner 112. According to alternative exemplary embodiments, flange molding surface 110 may extend from primary molding surface 108 at any suitable angle, such as between 0° and 180°, or between 30° and 150°, or between 80° and 100°.

After composite component 102 is laid in mold 104, flange corner 112 is formed by positioning flange shoe tool 106 along an edge 114 of composite component 102 to form flange corner 112 and a flange 116, or to form an inboard face and fillet of composite component 102. Flange shoe tool 106 may be mounted in mold 104 using a suitable mechanical fastener, such as a bolt 120. More specifically, bolt 120 may pass through a slotted hole 122 which allows flange shoe tool 106 to move along the vertical direction V. A vacuum bagging process, discussed below, may be used to draw flange shoe tool 106 into a fully engaged position with mold 104. To assist in drawing flange shoe tool 106 down into flange corner 112, mold 104 defines an angled lip 124 and flange shoe tool 106 defines a chamfered corner 126. As the vacuum is increased during the vacuum bagging process, angled lip 124 and chamfered corner 126 engage each other to pull flange shoe tool 106 into a fully engaged position with flange corner 112 (i.e., towards primary molding surface 108). According to the illustrated exemplary embodiment, flange shoe tool 106 is designed such that a clearance gap 128 exists between flange molding surface 110 and a side of the flange shoe tool 106. This ensures that flange shoe tool 106 will not “bottom out” on flange molding surface 110, thereby resulting in an insufficiently formed flange corner 112.

As best illustrated in FIG. 4, when flange shoe tool 106 is in the fully engaged position with composite component 102 and mold 104, a chamber 130 is defined adjacent edge 114 of composite component 102. Chamber 130 is one continuous passage that extends along both the lateral direction L and the transverse direction T around tooling assembly 100. In addition, mold 104 defines a plurality of venting passageways 132. Venting passageways 132 extend along either the lateral direction L or the transverse direction T through flange molding surface 110 of mold 104. More specifically, mold 104 may define the plurality of venting passageways 132 extending through flange molding surface 110 such that the venting passageways 132 are spaced out around the entire perimeter of mold 104. According to the illustrated embodiment, venting passageways 132 are spaced apart from each other by less than approximately four inches. Moreover, venting passageways 132 are in fluid communication with chamber 130.

As explained above, composite component 102 is constructed of a composite material comprising a plurality of fabric plies impregnated with a matrix material. Notably, this composite material is cured in tooling assembly 100 by placing mold 104 with attached flange shoe tools 106 into a vacuum bag and evacuating gases while in an oven or other high temperature environment. Chamber 130 and venting passageways 132 provide a pathway for evacuation of such gases, e.g., volatile compounds such as ethanol and methanol. By allowing for proper evacuation of these gases, porosity in flange 116 and flange corner 112 may be reduced and the strength of composite component 102 may be improved.

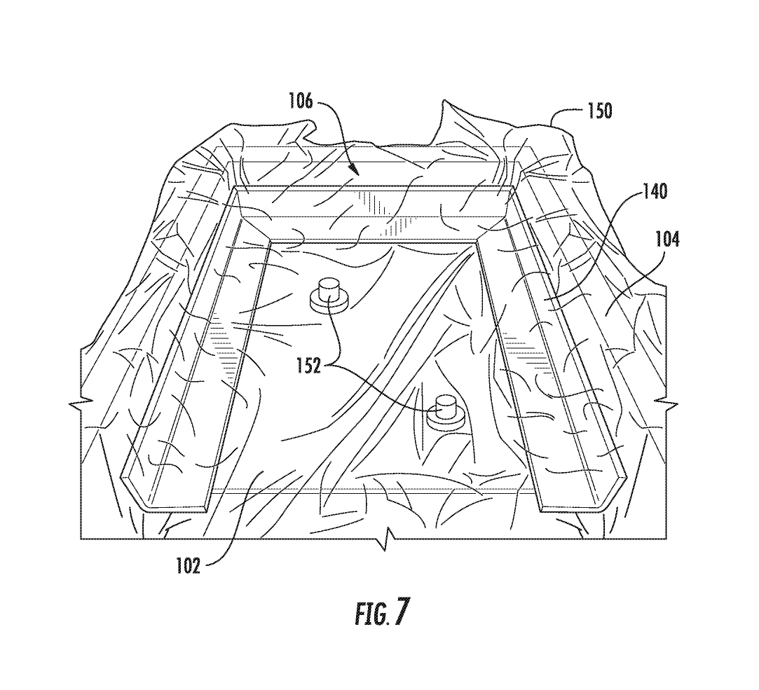

Referring now to FIGS. 5 and 6, in order to further reduce porosity and improve the strength of the finished composite component 102, a debulking procedure may be performed to preform flange corner 112 of composite component 102 as the impregnated fabric plies are laid. The debulking procedure generally includes periodically applying pressure and heat to composite component 102 as fabric plies are laid in mold 104 to reduce the volume of the fabric plies, thus removing the bulk, or de-bulking, and forming flange corner 112. To achieve this debulking, tooling assembly 100 may further include a first debulking tool 140 having a first radius R₁. First debulking tool 140 is used to press a first plurality of fabric plies 142 into flange corner 112. For example, as illustrated in FIG. 6, the first plurality of fabric plies 142 may include two plies. First debulking tool 140 is pressed into flange corner 112 to begin forming flange 116 and ensuring compact fit of the first plurality of fabric plies 142 in flange corner 112.

After the first plurality of fabric plies 142 has been debulked, a second debulking tool 144 may be used to debulk a second plurality of fabric plies 146. In this regard, the second plurality of fabric plies 146 may be laid in mold 104 on top of the previously debulked first plurality of fabric plies 142. Second debulking tool 144 is then used to press the second plurality of fabric plies 146 into flange corner 112 in the same manner as described above. For example, as illustrated in FIG. 6, the second plurality of fabric plies 146 may include five plies. Second debulking tool 144 presses the first and second plurality of fabric plies 142, 146 (e.g., seven total plies) into flange corner 112 to ensure a compact fit as described above.

Notably, due to the thickness of the plies and the geometry of flange corner 112, second debulking tool has a second radius R₂ that is smaller than first radius R₁. In this manner, flange corner 112 may be progressively and compactly formed to improve the preform of composite component 102 and help reduce porosity in the final composite component 102. Although tooling assembly 100 is described above as using two debulking tools 140, 144 to debulk two pluralities of fabric plies 142, 146, it should be appreciated that this two-step debulking procedure is used only for the purpose of explanation. According to alternative embodiments, any suitable number of debulking tools with progressively decreasing radii may be used to debulk any particular number of fabric plies to create a composite component. Moreover, aspects of the present subject matter may be applied to debulking processes using debulking tools with progressively increasing radii as well, e.g., such as when laying a composite material on a male flange.

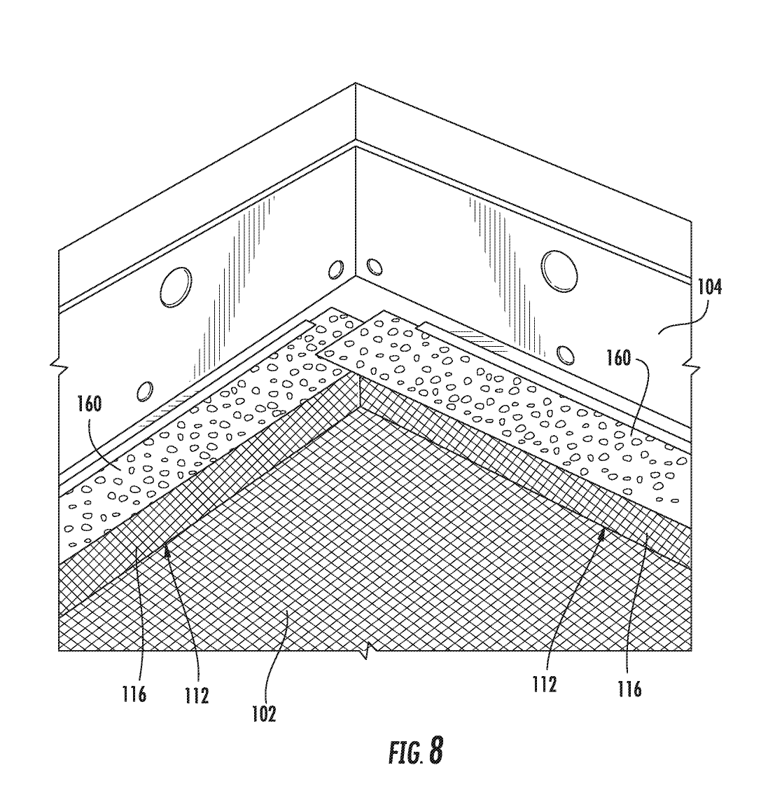

In order to further assist in debulking the fabric plies of composite component 102 a vacuum bagging procedure may be used to compact the fabric plies and remove gases during debulking and final curing. For example, continuing the example from above, a vacuum bagging procedure may be performed with both first debulking tool 140 and second debulking tool 144. According to alternative embodiments, the vacuum bagging procedure may be performed only with the second debulking tool 144. As illustrated in FIG. 7, the first vacuum bagging procedure may generally include placing mold 104, the preform of composite component 102, and first debulking tool 140 into a vacuum bag 150. A vacuum is then used to draw a vacuum on vacuum bag 150, e.g., through vacuum ports 152. The vacuum evacuates air and gases from vacuum bag 150, which also exerts a compressive force over the entire surface of the preform of composite component 102 and to first debulking tool 140. In this manner, first debulking tool 140 is pulled into flange corner 112, the entire preform of composite component 102 is compacted, and gases are drawn out of the composite preform. The same procedure may be performed with second debulking tool 144 after additional fabric plies are laid. In this manner, the composite preform is progressively compacted, volatile gases are removed, resin is distributed within the fabric plies, and porosity in the final composite component 102 may be reduced.

After the debulking steps have been completed and the composite preform is ready for final molding, flange shoe tool 106 may be mounted to mold 104 as described above. In addition to securing flange shoe tool 106 using bolt 120, tooling assembly 100 and the entire preform of composite component 102 may be vacuum bagged in a manner similar to that described for the debulking procedure. In this regard, mold 104, composite component 102, and flange shoe tool 106 may all be placed in a vacuum bag, e.g., vacuum bag 150. The entire vacuum bag 150 assembly may be fired to cure composite component 102. The gases generated during curing may be evacuating through vacuum ports 152, the composite component 102 may be compacted, and flange shoe tool 106 may be tightly drawn into flange corner 112 to form the final composite component 102.

Gases trapped in flange corner 112 are drawn out of vacuum bag 150 through chamber 130 and venting passageways 132. Notably, resin (or another matrix material) may, in certain embodiments, be drawn with the gases as vacuum bag 150 is evacuated and pressure is applied by flange shoe tool 106. As a result, the resin may clog chamber 130 and venting passageways 132, thus preventing further evacuation of gases. The trapped gases in the composite component 102 result in porosity which reduces the strength of the composite component 102. More particularly, when venting passageways 132 become clogged with resin, air and volatile gases become trapped in flange corner 112, resulting in strength issues.

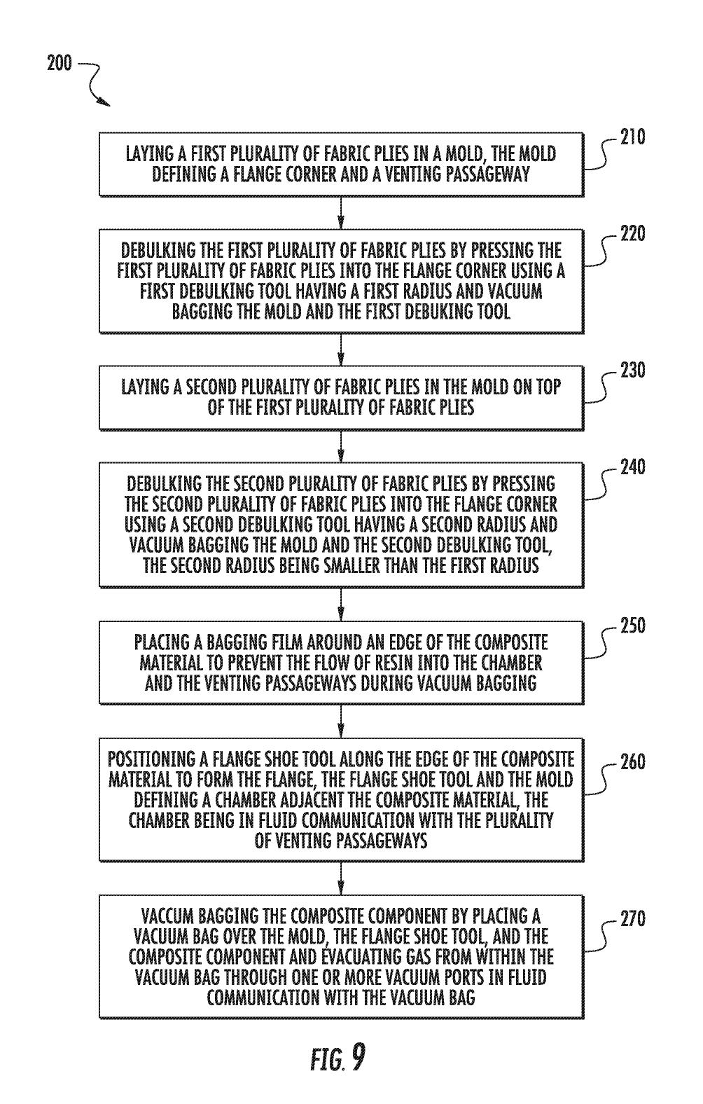

As best shown in FIG. 8, to prevent the clogging of chamber 130 and venting passageways 132, a bagging film 160 is placed around edge 114 (see FIG. 4) of the composite material to prevent the flow of resin into chamber 130 and venting passageways 132 during the vacuum bagging process. Bagging film 160 is a gas-permeable tape, such that gases may flow freely through bagging film 160 to chamber 130 and venting passageways 132. In this manner, gases may be evacuated without excessive resin flow. According to an exemplary embodiment, bagging film 160 is selected from a group consisting of perforated Kapton and perforated Teflon. However, it should be appreciated that any suitable gas-permeable material may be used according to alternative embodiments.

Now that the construction and configuration of tooling assembly 100 and the various processes for manipulating a preform of composite component 102 have been presented, an exemplary method 200 of forming a composite component will be described. Method 200 can be used to form any composite component. For example, method 200 may be utilized to form composite component 102. It should be appreciated that some or all of the steps listed in method 200 may be used to form a composite component having any suitable shape and including any suitable number or type of fabric plies. In this regard, the use of composite component 102 is used only for the purpose of explanation, and is not intended to limit the scope of the present subject matter.

Referring now specifically to FIG. 9, method 200 includes, at step 210, laying a first plurality of fabric plies in a mold, the mold defining a flange corner and a venting passageway allowing for the escape of gas. At step 220, method 200 includes debulking the first plurality of fabric plies by pressing the first plurality of fabric plies into the flange corner using a first debulking tool having a first radius and vacuum bagging the mold and the first debulking tool. As explained above, the vacuum bagging procedure removes gases from the fabric plies, compacts the fabric plies, and distributes the resin within the fabric plies for lower porosity and increased strength.

Method 200 includes, at step 230, laying a second plurality of fabric plies in the mold on top of the first plurality of fabric plies and a similar debulking procedure is performed. More specifically, at step 240, method 200 includes debulking the second plurality of fabric plies by pressing the second plurality of fabric plies into the flange corner using a second debulking tool having a second radius and vacuum bagging the mold and the second debulking tool. Notably, the second radius is smaller than the first radius to progressively compact the plurality of fabric layers in a manner that results in a tighter corner, less porosity, and increased strength of the composite component. It should be appreciated that the process of laying fabric plies and debulking with debulking tools with progressively increasing radii may be repeated as many time as necessary with any particular number of plies to form a composite component having a desired thickness, shape, and porosity.

After all fabric plies are laid and the composite preform is formed, to prevent the flow of resin into the chamber and the venting passageways during vacuum bagging, step 250 includes placing a bagging film around an edge of composite preform. Step 260 includes positioning a flange shoe tool along the edge of the composite material to form the flange, the flange shoe tool and the mold defining a chamber adjacent the composite material, the chamber being in fluid communication with the plurality of venting passageways. Finally, at step 270, method 200 includes vacuum bagging the composite preform and curing to form the final composite component. More specifically, for example, a vacuum bag 150 is placed over the mold 104, the flange shoe tool 106, and the composite component 102 and gas is evacuated from within the vacuum bag 150 through one or more vacuum ports 152 in fluid communication with the vacuum bag 150. The resulting composite component 102 has a flange 116 with a more precisely formed flange corner 112 having less porosity and improved strength.

In sum, the present subject matter provides a tooling assembly and method for forming a flange of a composite component. The tooling assembly includes a mold configured to receive a composite material which may include a plurality of fabric plies impregnated with resin. The fabric plies may be debulked as they are being laid using a plurality of debulking tools, with the radius of each debulking tool growing as additional fabric plies are laid. A gas-permeable bagging material may be placed along the edge of the composite material to restrict resin flow while allowing for outgassing. The tooling assembly may further include a flange shoe tool that is joined with the mold to form the flange along an edge of the composite material. The mold and flange shoe tool may define a chamber and venting passageways that allow gases such as volatile compounds to escape while the composite component is being cured.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A tooling assembly for forming a flange of a composite component, the tooling assembly comprising:
a mold configured to receive a composite material, the mold defining a primary molding surface and a flange molding surface, the flange molding surface extending at an angle relative to the primary molding surface, the mold defining a plurality of venting passageways that extend through the flange molding surface; and
a flange shoe tool that is joined with the mold to form the flange of the composite material, the flange shoe tool and the mold defining a chamber adjacent an edge of the composite material, the chamber being in fluid communication with the plurality of venting passageways.

2. The tooling assembly of claim 1, wherein the composite material comprises fabric plies impregnated with a matrix material.

3. The tooling assembly of claim 2, wherein the fabric plies are carbon fiber fabric plies or glass fiber fabric plies and the matrix material is a resin.

4. The tooling assembly of claim 2, wherein the fabric plies are ceramic fiber plies and the matrix material is a ceramic matrix material.

5. The tooling assembly of claim 1, wherein the composite component is a section of a fan case of a gas turbine engine.

6. The tooling assembly of claim 1, wherein the tooling assembly further comprises:
a first debulking tool having a first radius, the first debulking tool being used to press a first plurality of fabric plies into a corner defined by the primary molding surface and a flange molding surface; and
a second debulking tool having a second radius, the second radius being smaller than the first radius, the second debulking tool being used to press a second plurality of fabric plies into the corner on top of the first plurality of fabric plies.

7. The tooling assembly of claim 1, further comprising a vacuum bagging assembly comprising:
a vacuum bag positionable over the mold, the flange shoe tool, and the composite component;
one or more vacuum ports in fluid communication with the vacuum bag; and
a vacuum for evacuating gas from within the vacuum bag.

8. The tooling assembly of claim 7, wherein a weight of the composite component is reduced by twenty-five percent after being processed in the vacuum bagging assembly.

9. The tooling assembly of claim 1, further comprising a bagging film for positioning around the edge of the composite material to prevent a flow of resin into the chamber and the venting passageways during a vacuum bagging process.

10. The tooling assembly of claim 8, wherein the bagging film is selected from a group consisting of perforated Kapton and perforated Teflon.

11. The tooling assembly of claim 1, wherein the angle between the primary molding surface and the flange molding surface is approximately 90 degrees.

12. A method of forming a flange of a composite component comprising:
laying a composite material in a mold, the mold defining a flange forming surface and a plurality of venting passageways;
positioning a flange shoe tool along an edge of the composite material to form the flange, the flange shoe tool and the mold defining a chamber adjacent to the composite material, the chamber being in fluid communication with the plurality of venting passageways; and
vacuum bagging the composite component by placing a vacuum bag over the mold, the flange shoe tool, and the composite component and evacuating gas from within the vacuum bag through one or more vacuum ports in fluid communication with the vacuum bag.

13. The method of claim 12, further comprising placing a bagging film around the edge of the composite material to prevent a flow of resin into the chamber and the venting passageways during vacuum bagging.

14. The method of claim 13, wherein the step of vacuum bagging the composite component lowers a weight of the composite component by twenty-five percent.

15. The method of claim 12, wherein the step of laying the composite material in the mold comprises:
laying a first plurality of fabric plies in the mold;
debulking the first plurality of fabric plies by pressing the first plurality of fabric plies into a flange corner using a first debulking tool having a first radius and vacuum bagging the mold and the first debulking tool;
laying a second plurality of fabric plies in the mold on top of the first plurality of fabric plies; and
debulking the second plurality of fabric plies by pressing the second plurality of fabric plies into the flange corner using a second debulking tool having a second radius and vacuum bagging the mold and the second debulking tool, the second radius being smaller than the first radius.

16. The method of claim 12, wherein the composite material comprises fabric plies impregnated with a matrix material.

17. The method of claim 12, wherein the flange is formed at an angle of approximately 90 degrees.

18. A method of forming a composite component from fabric plies impregnated with a matrix material, the method comprising:
laying a first plurality of fabric plies in a mold, the mold defining a flange corner and a venting passageway allowing for the escape of gas;
debulking the first plurality of fabric plies by pressing the first plurality of fabric plies into the flange corner using a first debulking tool having a first radius and vacuum bagging the mold and the first debulking tool;
laying a second plurality of fabric plies in the mold on top of the first plurality of fabric plies; and
debulking the second plurality of fabric plies by pressing the second plurality of fabric plies into the flange corner using a second debulking tool having a second radius and vacuum bagging the mold and the second debulking tool, the second radius being smaller than the first radius.

19. The method of claim 18, further comprising:
positioning a flange shoe tool along an edge of the first and second plurality of fabric plies to form the flange, the flange shoe tool and the mold defining a chamber adjacent the composite component, the chamber being in fluid communication with the venting passageway; and
vacuum bagging the composite component by placing a vacuum bag over the mold, the flange shoe tooling, and the composite component and evacuating gas from within the vacuum bag through one or more vacuum ports in fluid communication with the vacuum bag.

20. The method of claim 19, further comprising placing a bagging film around the edge of the composite material during vacuum bagging,
wherein the bagging film is configured for preventing the flow of resin into the chamber and the venting passageway but allowing gas to escape, and
wherein the step of vacuum bagging the composite component is stopped after a weight of the composite component is reduced by twenty-five percent.
